(19) United States
(12) Patent Application Publication
(10) Pub. No.: US 2005/0179515 A1
(43) Pub. Date: Aug. 18, 2005

(54) Transformer insulation film structure

(75) Inventor: Kuo-Chen Huang, Taoyuan Hsien (TW)

Correspondence Address: TROXELL LAW OFFICE PLLC, Suite 1404, 5205 Leesburg Pike, Falls Church, VA, 22041, US

(73) Assignee: Kwan Chiu Radio Mfg., Co., Ltd.

(21) Appl. No.: 10/833,156

(22) Filed: Apr. 28, 2004

(30) Foreign Application Priority Data
Feb. 13, 2004 (TW) 93202038

(51) Int. Cl. H01F 27/30

(52) U.S. Cl. 336/208

(57) ABSTRACT

A transformer insulation film structure mainly comprises a winding roll for insulation film and coils. The insulation film is cut at both sides to form a number of flaps, which dimensions depend on the transformer specifications. Due to restraint by the width of the winding roll, the side flaps of the insulation film stand up and overlap after repeated winding to achieve the required insulation thickness. Through insulation film winding and overlapping, we can achieve the required surface distance on both sides of the winding roll. By this means, we can achieve the target surface distance without the need of a complicated structure in the traditional technology, so we will benefit from the simplified structure.

### BACKGROUND OF THE INVENTION

1. Field of the Invention

The invention is related to a transformer insulation film structure. Especially it refers to a structure that after repeated winding can achieve the surface distance required for the first and the second sides. It can improve the complication inherent in a repeated manufacturing process with the traditional technology and the material cost. The progressiveness in the improvement is sufficient to prove its commercial value.

2. Description of the Related Art

As shown in FIG. 1 and FIG. 2, the traditional transformer is composed of a main unit 1′, a resinous layer 2′ and coils 3′. To meet the safety regulation, it is necessary to put a certain height of resinous layer 2′ on both sides of a winding roll 11′ of the main unit 1′. Traditionally, the resinous layer 2′ was made from repeated winding of films with a specific width to achieve a certain height. However, the winding process was lengthy. Moreover, one transformer needed double winding time to put on the resinous layer 2′ for both sides. The process was laborious and time consuming with zero tolerance. When the winding of the first layer of coils 3′ is completed between the two resinous layers 2′, the outside of the coils 3′ needs an isolation layer 4′ to achieve the so-called first and second side surface distances.

Please refer to FIG. 3 and FIG. 4. Another traditional structure that tended to improve the laborious and time-consuming drawbacks adopted a sleeve-type connection. Through the connection between an outer sleeve 5′ and an inner sleeve 6′, the coils 3′ are wound on the winding rolls 51′ and 61′ of the outer sleeve 5′ and the inner sleeve 6′ respectively. Thus, the required surface distance is achieved.

Nevertheless, no matter what structure mentioned above, there are always drawbacks as below:

1. The resinous layer needs to be repeatedly wound on both sides of the winding roll. The winding process is laborious and time-consuming.

2. Since the wounded resinous layer needs to reach a certain height to meet the surface distance requirement, the winding height must be accurate.

3. Since the sleeve-type transformer structure requires connection between the outer sleeve and the inner sleeve, the material cost is high and disadvantageous for mass production.

4. Since the inner and outer sleeve structure is made to fit various transformer specifications, the manufacturing cost is high.

### SUMMARY OF THE INVENTION

In view of the drawbacks with the traditional transformer in terms of complicated and lengthy process and high cost, the inventor of the present invention has made improvement by providing a new transformer insulation film structure with commercial value to meet the industrial needs.

The main objective of the invention is to provide an improved transformer insulation film structure. With the insulation film, only one time winding can achieve a certain height of insulation layer on both sides of the winding roll. The invention saves processing time. Particularly, the folding flaps overlap during the winding process to achieve the required surface distance and prove to possess commercial value.

### BRIEF DESCRIPTION OF THE DRAWINGS

FIG. 1 is a three-dimensional illustration for a traditional transformer insulation film.

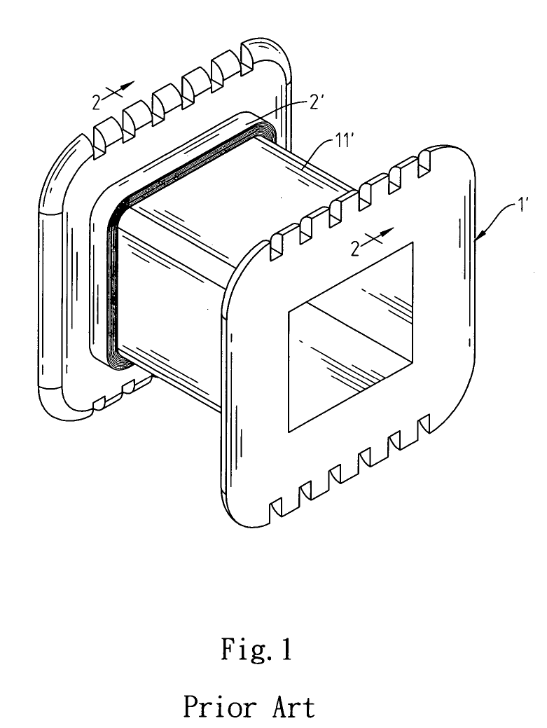

FIG. 2 is a cross-section view of a traditional transformer through two times of winding coils.

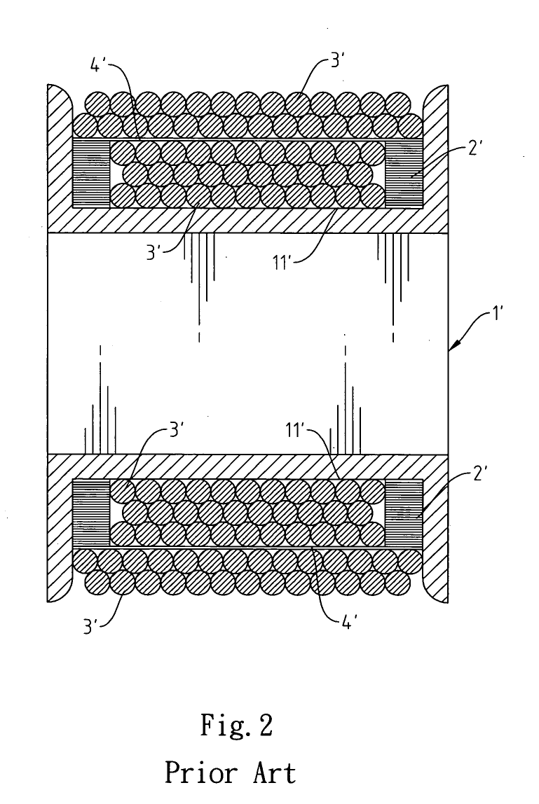

FIG. 3 is a three-dimensional disassembly view for another traditional transformer.

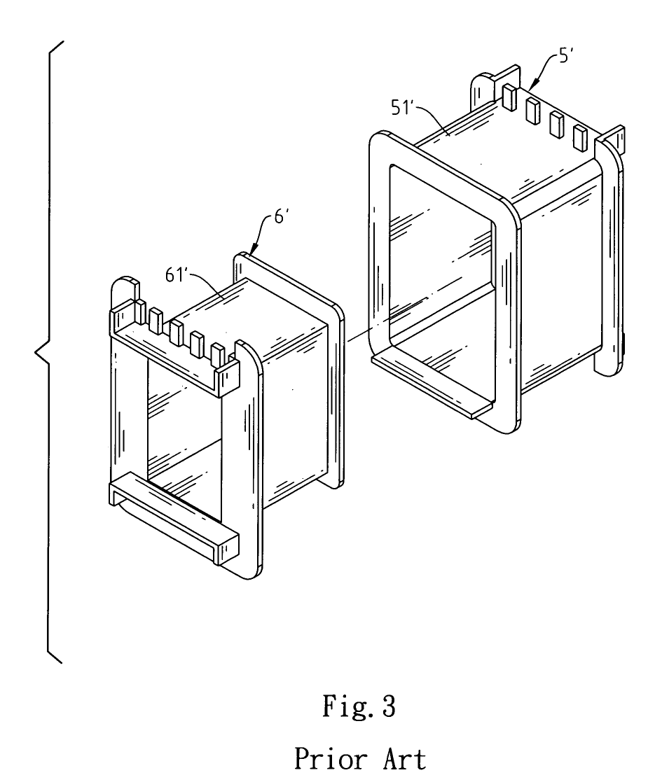

FIG. 4 is a partial cross-section view of the structure as in FIG. 3 after the winding of coils.

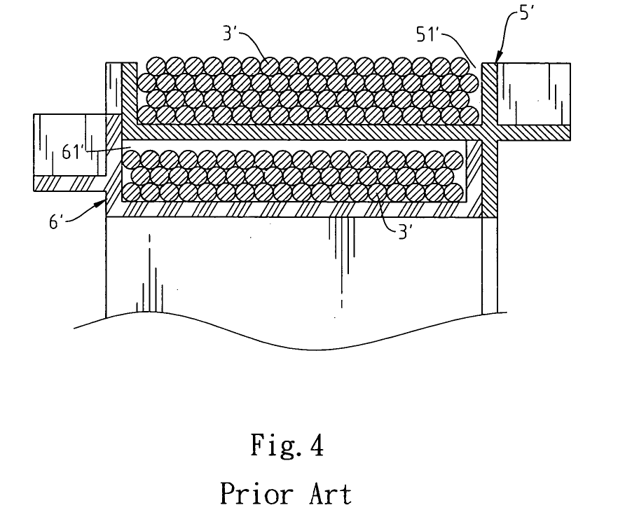

FIG. 5 is a three-dimensional illustration for the insulation film layer for the present invention.

FIG. 6 is a cross-section view of the transformer for the present invention.

### DETAILED DESCRIPTION OF THE INVENTION

With references to the Figures, the details of the implementation of the invention are given below:

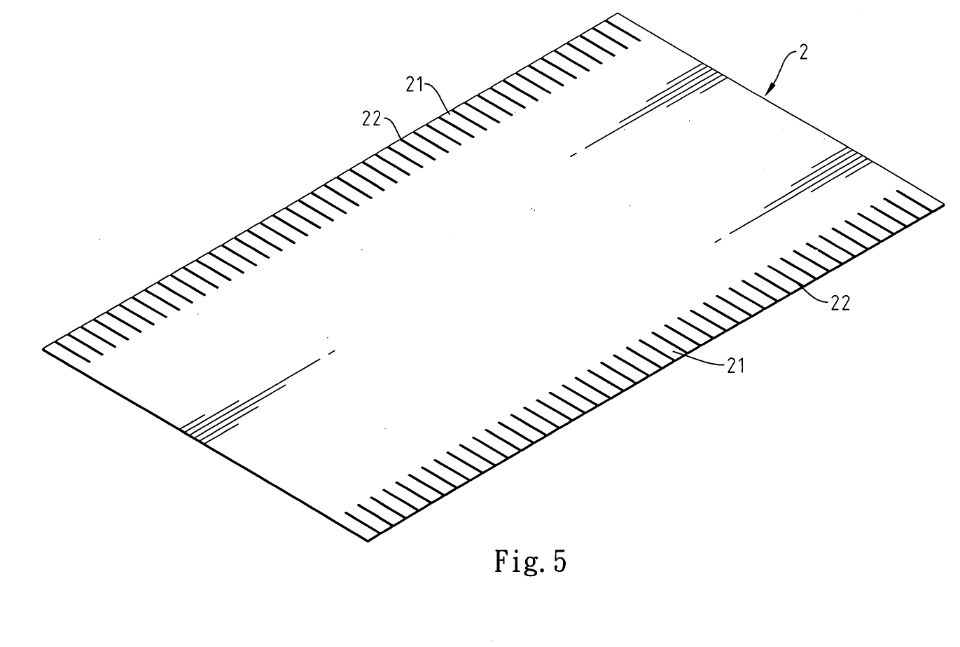

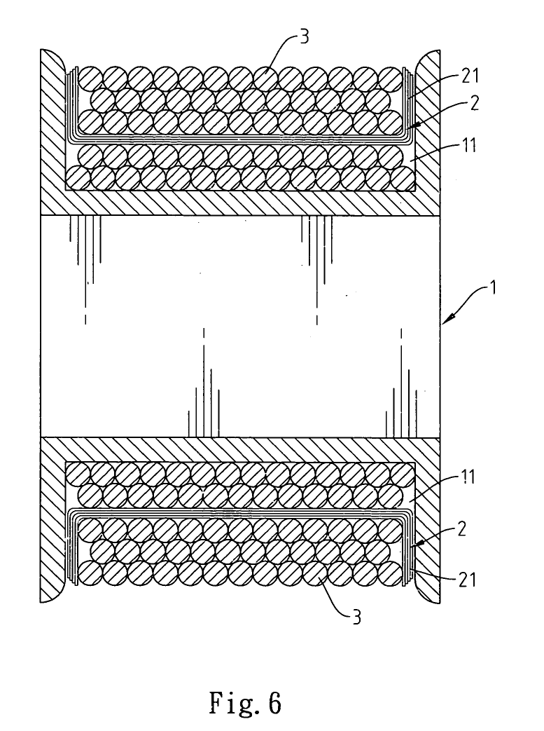

Please refer to FIG. 5 and FIG. 6. The transformer insulation film structure in the present invention mainly comprises a plastic main unit 1, an insulation film layer 2 and coils 3. The main unit 1 has a winding roll 11 for winding coils 3. Inside the winding roll 11, there is an insulation film layer 2 to provide electric insulation and compression resistance and surface distance.

The insulation film 2 at the winding roll 11 of the main unit 1 is plastic with compression resistance and electric insulation and meets industrial standards. The insulation film 2 is cut on both sides with a number of tangential lines 22 to form folding flaps 21. The dimensions of each flap 21 depend on transformer specifications. The longer folding flap 21 becomes higher after folding and gives longer surface distance.

When the first layer of coils 3 is wound on the winding roll 11 to a certain degree, an insulation film layer 2 is put on the first layer of coils 3. When the insulation film 2 is wound on the winding roll 11, the folding flaps 21 on both sides of the insulation film 2 stand up due to restraint by the width of the winding roll 11. After the insulation film is repeatedly wound, the folding flaps overlap. When the winding reaches to a certain degree, the folding flaps 21 achieve a certain thickness. The length of the pre-cut folding flap 21 determines the height of the standing flap 21 after winding. When the second coils 3 are wound, they are situated in the space that the wound insulation film layer forms. After two times of winding coils, the height obtained by the folding flaps 21 of the insulation film layer 2 can achieve the required surface distance between the first side and the second side.

In summary, the transformer insulation film structure for the present invention only needs one repeated winding to achieve the required insulation thickness and surface distance. The present invention is able to improve the drawbacks with the traditional structure in terms of lengthy process and high cost and proves to possess commercial value. Therefore, the invention meets the patent requirements for the innovation and progressiveness in a new product type. A patent application is thus filed accordingly.

1. A transformer insulation film structure mainly comprises a winding roll, an insulation film layer and coils with features in:
The insulation film layer is cut with tangential lines at both sides to form a number of flaps, which dimensions depend on the transformer specifications. Due to restraint by the width of the winding roll, the folding flaps at both sides of the insulation film stand up and overlap after repeated winding;
When the first layer of coils is wound on the winding roll to a certain degree, an insulation film layer is put on; the folding flaps on both sides of the insulation film stand up to a certain height due to restraint by the width of the winding roll; the folding flaps also achieve a certain thickness for the second winding of coils; through two times of winding of coils, the height and thickness of the folding flaps of the insulation film are sufficient to achieve the required surface distance for the first side and the second side.
